(19) United States
(12) Patent Application Publication
(10) Pub. No.: US 2013/0115574 A1
(43) Pub. Date: May 9, 2013

(54) Pneumatic device utilizing controlled pressure release

(71) Applicant: Forest A. Hatcher, Flagler Beach, FL (US)

(72) Inventor: Forest A. Hatcher, Flagler Beach, FL (US)

(21) Appl. No.: 10/794,608

(22) Filed: Mar. 6, 2004

Related U.S. Application Data
(60) Provisional application No. 60/452,791, filed on Mar. 8, 2003.

(51) Int. Cl. F41A 5/00; G09B 19/00

(52) U.S. Cl. CPC F41A 5/00; G09B 19/00
USPC 434/11

(57) ABSTRACT

This application details a device which utilizes the controlled, explosive release of a pressurized fluid to simulate the effects of an explosive event.

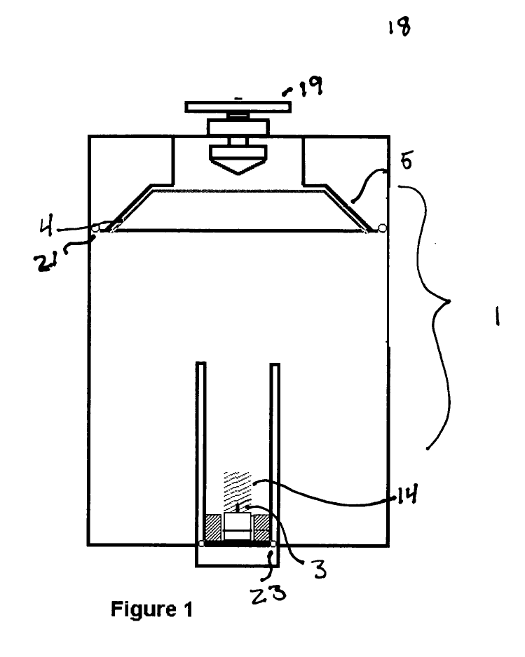

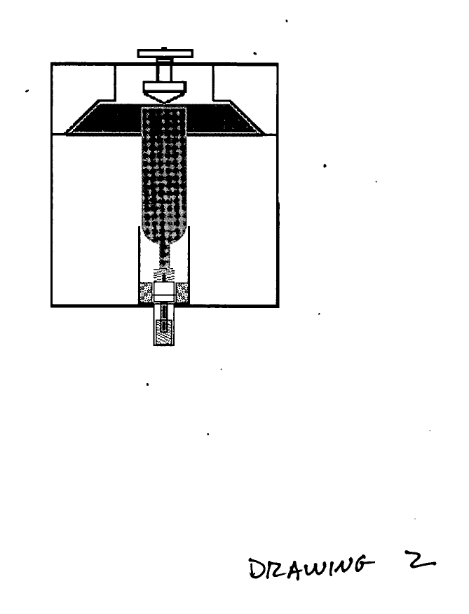

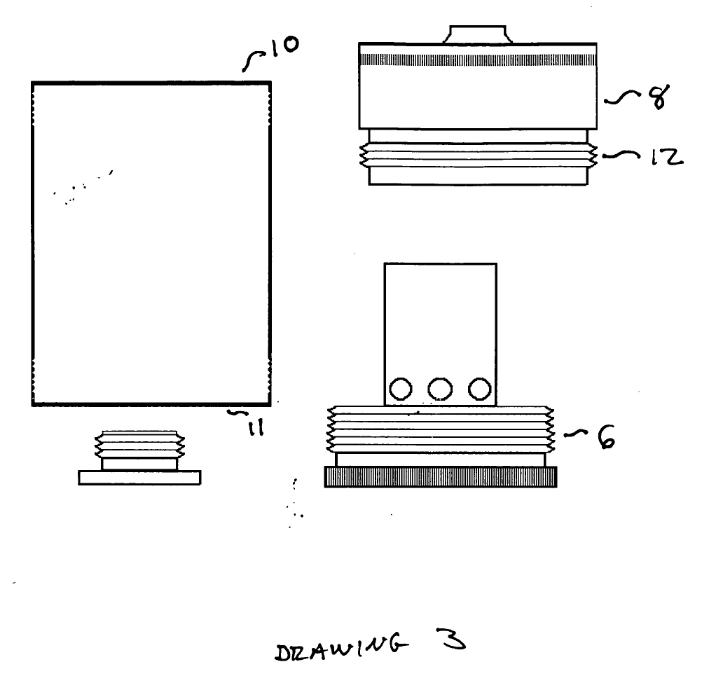

### CROSS-REFERENCE TO RELATED APPLICATION

The present application is based on and claims priority to U.S. Provisional Application Ser. No. 60/452,791 filed on Mar. 8, 2003.

### BACKGROUND OF THE INVENTION

This invention relates to simulated weapon devices, simulated explosive devices, nonlethal and less-than-lethal weapon systems. This invention was created to provide for the development and use of non-pyrotechnically based stand-alone weapons and weapon simulators, such as mines or booby-traps.

### BRIEF DESCRIPTION OF THE DRAWINGS

Drawing 1 contains a diagram of one embodiment of the device and its related components

Drawing 2 contains a diagram of an additional embodiment of the device and its related components.

Drawing 3 contains diagrams of components of the device

### DETAILED DESCRIPTION OF THE INVENTION

The Method for Creating Controlled Pressure Release in a Pneumatic Device consists of five primary components. These are the Main Body (1), a Pressurized Gas Supply (2), a Piercing Pin (3) or related means for introducing pressurized gas from the Gas Supply, A Frangible Pressure Control Membrane (4) and a Pressure Control Membrane Retainer (5).

The Main Body consists of four parts—A Body (6), a Piercing Pin End Cap (7), a Open End Cap (8) and a Volume Chamber (9). The Body (6) consists of a walled element with a first open end (10) and a second open end (1 I) connected by a chamber (9) running parallel with the long axis of the Body (6) The First Open End (10) and Second Open End (1 I) are configured with a releasable retaining method (12), sufficient to hold the Piercing Pin End Cap (7) and the Open End Cap(8) in place under fluid pressure.

The Piercing Pin End Cap (7) is releasabley retained by screws or other method (12) in the Body (6). When attached to the Body (6), the Piercing Pin End Cap (7) will create a seal at one open end (11) of the Body (6) creating a partially closed volume. Running around the circumference of the Piercing Pin End Cap is a flexible seal (21). Centered within the Piercing Pin End Cap (7) and oriented so that it is contained within the interior of the Volume Chamber (9) is a Piercing Pin (13), which consists of a conical pin, capable of breaking the seal of the pressure vessel (2) when placed under sufficient force.

The Piercing Pin (13) may also utilize a flexible seal (23) to prevent leaks form the Volume Chamber.

Contiguous to the Piercing Pin (13) and oriented along the same axis as the Piercing Pin is a Return Device (14), consisting of a compressible element that will return to its original shape and size upon removing a load that it is placed under, such as a spring, and having sufficient force to push the Pressure Vessel (2) away from the Piercing Pin (13).

The Return Device (14) must be shaped such that it can fit around the circumference of the Piercing Pin (13) but not around the circumference of the Pressure Vessel (2).

The Open End Cap (8) is releasabley retained by screws or other method (12) in the Body (6). When attached to the Body (6), the Open End Cap (8) creates a partial seal at one open end (II) of the Body (6) creating a partially closed volume. The Open End Cap (8) consists of the Body of the End Cap, a means for receiving the retaining method (12) and Conduits (15) that form an opening that passes through the End Cap (8) and communicates with the interior Volume Chamber (9) of the Body (6). Retained within the Open End Cap is the Plunger Assembly (18). The Plunger Assembly consists of the Plunger Top (19), the Plunger Body (20) and the Plunger Return Spring (21). Running around the circumference of the Open End Cap is a flexible seal (22).

The Interior side of the Open End Cap (8) is shaped with a tapered or stepped circular Retaining Wall (16) for retaining the Frangible Pressure Control Membrane (17). The Retaining Wall (16) is concentric with the Conduit (15) and the Interior Volume Chamber (9). The outer diameter of the Retainig Wall is of a diameter less that the interior diameter of the Volume Chamber (9) and greater that the outer diameter of the Frangible Pressure Control Membrane (17); the Retaining Wall provides for a smooth, uninterrupted surface which is capable of providing for a pressure seal when the Frangible Pressure Control Membrane is under pressure.

The Frangible Pressure Control Membrane (17) consists of a material capable of remaining intact until it reaches a pressure threshold. Upon reaching the pressure threshold, the material will catastrophically fail, allowing the pressurized fluid within the Volume Chamber (9) of the device to pass through Conduit (15).

The Pressurized Gas Supply (2) consists of a commercially available sealed pressure vessel, such as a 12-gram C02 cartridge or similar device which is capable of retaining a fixed volume of pressured gas at a fixed psi.

In application, one embodiment of the device works in the following manner: The Piercing Pin End Cap (7) is fixed to the Body (6) of the device using the retaining means (12). A Pressurized Gas Vessel (2) is placed within the interior volume chamber (9) of the device, oriented so that its seal is adjacent to the piercing pin (13) and the Return Device (14). A Frangible Pressure Control Membrane (17) is placed within the Open End Cap (8), such that its outer diameter is contiguous to the Retaining Wall (16).

The Open End Cap is then fixed to the Body (6) of the device using the retaining means (12).

The Plunger (18) is oriented so that it is exposed into a working environment (such as just above ground level). An external force, acting upon the Plunger (18), Presses down upon the Frangible Pressure Control Membrane (17), which in turn presses against the Pressure Vessel (2), pushing it down against the Return Device (14) and the Piercing Pin (13).

The Piercing Pin (13) then creates an opening in the Pressure Vessel (2). Once the external force is removed from the device, the Return Device (14) forces the Pressure Vessel (2) away from the Piercing Pin (I J) and allows the pressurized fluid contained within the Pressure Vessel (2) to be released into the Volume Chamber (9) of the device.

The pressurized fluid will continue to vent into the Volume Chamber until the pressure threshold of the Frangible Pressure Control Membrane (17) is reached, after which the Frangible Pressure Control Membrane will fail, allowing the pressurized fluid to explosively pass outside of the device through the conduit (15).

In an alternate embodiment of the device, an electronic switching device (25), such as a solenoid, can be used to remotely activate the device.

1: A method for simulating an explosive event utilizing a frangible membrane which catastrophically fails when subjected to a pre-determined level of fluid pressure.

2: The method of claim 1 wherein the frangible membrane is constructed from a plastic element or plastic-like element.

3. The method of claim 1 wherein the frangible membrane is constructed from a paper element or paper-like element.

4: The method of claim 1 wherein the frangible membrane is constructed from a rubber or rubber-like element.

5. (canceled)

6. (canceled)

7: A device incorporating the method of claim 1 capable of expelling a projectile.

8: A method for simulating an explosive event utilizing a frangible membrane which catastrophically fails when subjected to a pre-determined level of fluid pressure, which incorporates a means for storing pressurized fluid and a means for controllably releasing the pressurized fluid into the device, said means activated by an external event.

9: A method for simulating an explosive event utilizing a frangible membrane which catastrophically fails when subjected to a pre-determined level of fluid pressure, which incorporates a means for storing pressurized fluid and a means for controllably releasing the pressurized fluid into the device, said means activated by an external event, said external event being the application of force to the plunger element.

10: A method for simulating an explosive event utilizing a frangible membrane which catastrophically fails when subjected to a pre-determined level of fluid pressure, which incorporates a means for storing pressurized fluid and a means for controllably releasing the pressurized fluid into the device, said means activated by an external event, the external event being the triggering of a remote electrical switch.

11: A method for simulating an explosive event utilizing a frangible membrane which catastrophically fails when subjected to a pre-determined level of fluid pressure, which incorporates a means for storing pressurized fluid and a means for controllably releasing the pressurized fluid into the device, said means activated by an external event, initiated by a radio-controlled device so that it can be remotely activated.

12: The device of claim 9 capable of expelling a projectile

13: The device of claim 9 capable of expelling a smoke stimulant.

14: The device of claim 9 capable of expelling a chemical agent simulator.

15. (canceled)
